(19) United States
(12) Patent Application Publication
(10) Pub. No.: US 2024/0104002 A1
(43) Pub. Date: Mar. 28, 2024

(54) Conversational Agent for System Troubleshooting and Problem Resolution

(71) Applicant: Citrix Systems, Inc., Ft. Lauderdale, FL (US)

(72) Inventors: Kiran Kumar, Bangaluru (IN); Vikramjeet Sandhu, Bengaluru (IN); Vivek Koni Raghuveer, Bengaluru (IN); Vinay George Roy, Bengaluru (IN)

(73) Assignee: Citrix Systems, Inc., Ft. Lauderdale, FL (US)

(21) Appl. No.: 17/934,574

(22) Filed: Sep. 22, 2022

(51) Int. Cl. G06F 11/36

(52) U.S. Cl. CPC G06F 11/3664

(57) ABSTRACT

A method of troubleshooting an application includes receiving, from an analytics engine, data representing a performance metric of the application and a tenant identifier associated with the application; sending, to the analytics service, a request to receive at least one user identifier associated with the tenant identifier; receiving, from the analytics service, at least one user identifier; selecting, from a database, a message based at least in part on the performance metric of the application; and sending the message to the application associated with the at least one user identifier.

### BACKGROUND

Information technology environments are often complex to operate and thus require expertise to manage. In some instances, end users may encounter anomalous or undesirable system behaviors but lack the know-how, facilities, or authority to troubleshoot and resolve the problem on their own. Analytical tools can be employed to help users, administrators, and support personnel identify anomalous conditions indicative of, for example, security, performance, and other operational concerns that may not otherwise be readily apparent. Once such conditions are identified, support personnel intervene to recover the environment from the condition or otherwise provide corrective support to the user. However, this process can be laborious, costly, and time consuming. Therefore, a need exists for improved troubleshooting and problem resolution techniques.

### SUMMARY

One example provides a method of troubleshooting an application. The method includes receiving, from an analytics engine, data representing a performance metric of the application and a tenant identifier associated with the application; sending, to the analytics service, a request to receive at least one user identifier associated with the tenant identifier; receiving, from the analytics service, at least one user identifier; selecting, from a database, a message based at least in part on the performance metric of the application; and sending the message to the application associated with the at least one user identifier.

In some examples, the method includes causing a user interface of the application to present a user interface element configured to cause, responsive to a user selection of the user interface element, an action to be performed on a client computing device executing the application. In some examples, the method includes receiving, from the application associated with the at least one user identifier, a user service request. In some examples, the method includes sending, to a natural language processor, an interpretation request based on the user service request; receiving, from the natural language processor, an interpretation result; and sending the interpretation result to the application associated with the at least one user identifier. In some examples, the method includes sending, to a ticketing service, a service ticket request based on the user service request. In some examples, the method includes retrieving, from a knowledge base, a knowledge base document based on the user service request; and sending the knowledge base document to the application associated with the at least one user identifier. In some examples, the data is first data, and the method includes receiving, from the analytics engine, second data representing performance metrics of the application hosted on a plurality of virtual computing sessions; and sending, responsive to receiving the second data, the message to an administrator of the virtual computing sessions.

Another example provides a computer program product including one or more non-transitory machine-readable mediums having instructions encoded thereon that when executed by at least one processor cause a process for troubleshooting an application to be carried out. The process includes receiving, from an analytics engine, data representing a performance metric of the application and a tenant identifier associated with the application; sending, to the analytics service, a request to receive at least one user identifier associated with the tenant identifier; receiving, from the analytics service, at least one user identifier; selecting, from a database, a message based at least in part on the performance metric of the application; and sending the message to the application associated with the at least one user identifier.

In some examples, the process includes causing a user interface of the application to present a user interface element configured to cause, responsive to a user selection of the user interface element, an action to be performed on a client computing device executing the application. In some examples, the process includes receiving, from the application associated with the at least one user identifier, a user service request. In some examples, the process includes sending, to a natural language processor, an interpretation request based on the user service request; receiving, from the natural language processor, an interpretation result; and sending the interpretation result to the application associated with the at least one user identifier. In some examples, the process includes sending, to a ticketing service, a service ticket request based on the user service request. In some examples, the process includes retrieving, from a knowledge base, a knowledge base document based on the user service request; and sending the knowledge base document to the application associated with the at least one user identifier. In some examples, the data is first data, and the process includes receiving, from the analytics engine, second data representing performance metrics of the application hosted on a plurality of virtual computing sessions; and sending, responsive to receiving the second data, the message to an administrator of the virtual computing sessions.

Yet another example provides a system comprising a storage and at least one processor operatively coupled to the storage, the at least one processor configured to execute instructions stored in the storage that when executed cause the at least one processor to carry out a process includes causing a graphical user interface (GUI) of the device to display content in an application window; receiving, from an analytics engine, data representing a performance metric of the application and a tenant identifier associated with the application; sending, to the analytics service, a request to receive at least one user identifier associated with the tenant identifier; receiving, from the analytics service, at least one user identifier; selecting, from a database, a message based at least in part on the performance metric of the application; and sending the message to the application associated with the at least one user identifier. In some examples, the process includes causing a user interface of the application to present a user interface element configured to cause, responsive to a user selection of the user interface element, an action to be performed on a client computing device executing the application. In some examples, the process includes receiving, from the application associated with the at least one user identifier, a user service request. In some examples, the process includes sending, to a natural language processor, an interpretation request based on the user service request; receiving, from the natural language processor, an interpretation result; and sending the interpretation result to the application associated with the at least one user identifier. In some examples, the process includes sending, to a ticketing service, a service ticket request based on the user service request. In some examples, the process includes retrieving, from a knowledge base, a knowledge base document based on the user service request; and sending the knowledge base document to the application associated with the at least one user identifier.

Other aspects, examples, and advantages of these aspects and examples, are discussed in detail below. It will be understood that the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a computing environment, in accordance with an example of the present disclosure.

FIG. 2 is a block diagram of a portion of the computing environment of FIG. 1, in accordance with an example of the present disclosure.

FIG. 3 is a data flow diagram for the computing environment of FIG. 1, in accordance with an example of the present disclosure.

FIGS. 4-7 are several graphical user interfaces that can be implemented in the computing environment of FIG. 1, in accordance with examples of the present disclosure.

FIG. 8 is a flow diagram of a method of troubleshooting an application within the computing environment of FIG. 1, in accordance with an example of the present disclosure.

FIG. 9 is a flow diagram of a method of troubleshooting an application within the computing environment of FIG. 1, in accordance with another example of the present disclosure.

FIG. 10 is a block diagram of a computing device configured to implement various systems and processes in accordance with examples disclosed herein.

### DETAILED DESCRIPTION

### Overview

Information technology environments include increasingly complex applications such as software as a service (SaaS) and other applications where at least some processing and data storage are distributed away from the local desktop or mobile device of the end user. The complexity is a function of not only the services rendered by the applications executing within the environment but also risks to the security of the environment. Operational management of such environments can be too difficult or impractical for end users to perform without technical assistance, thus necessitating additional resources for facilitating system operations. These resources typically include system administrators and other support personnel who perform maintenance, installations, upgrades, assistance, and other activities for achieving the service and security requirements of the environment. Such activities can be performed in response to concerns raised by the users, or by proactively or reactively carrying out preventative and corrective measures.

To achieve level of service requirements, administrators and support personnel need visibility into the status and context of user activity within the environment. For example, it may be necessary for personnel to identify rogue processes, suspicious activity, or inconsistent performance as an initial step in troubleshooting or preempting a user concern. Certain analytics tools, such as Citrix Analytics by Citrix Systems, Inc., of Ft. Lauderdale, Florida, enable corporate administrators to obtain proactive and prescriptive insights into the environment for resolving issues as they arise or to take steps to mitigate service failures. For instance, Citrix Analytics for Security allows administrators to monitor and identify inconsistent or suspicious activity within an environment; Citrix Usage Analytics provides visibility into user interaction with various applications within the environment; and Citrix Analytics for Performance provides user-centric experience scores, application, and infrastructure performance scores that can be used to improve the user experience.

However, it is appreciated that existing solutions are still insufficient for evolving computing environments. For example, personnel tasked with maintaining the environment may not be aware of service issues until they are raised by the user. Once the user raises a concern, personnel must perform an investigation to first identify the cause and potential solutions, and next to execute appropriate recovery tasks. In the meantime, the user may not experience the expected level of service, which can be costly and time-consuming.

For example, a user must often contact support personnel for assistance with a concern about a computing device, application, or session that is not performing as expected. Typically, the user can request such assistance via commonly available modes such as telephone, email, online chat, or social media. The support personnel then begin troubleshooting by talking to the user and collecting information to identify the cause of the concern. This process can include creating a so-called service ticket, which is a mechanism for responding to and managing the concern. For example, the service ticket can be used to communicate the concern to a specialist who is most suitable for taking corrective action and affecting a resolution. The service ticket can be used for coordinating the response with other support personnel as needed and for identifying the status of the response at a given time during the resolution process (e.g., for tracking the progress of the response, collecting reporting metrics, and other diagnostic and evaluation purposes).

However, the use of support personnel to address user concerns is labor intensive and time consuming from initiation of the user's request for assistance to closure of the service ticket. For instance, the user may not have access to certain information needed to address the concern, such as detailed knowledge of system performance or other troubleshooting data. In some instances, existing knowledge base information that may be useful for resolving a concern is extensive and thus difficult to search and consume. This requires the support personnel to expend significant time and effort investigating the issue and researching potential resolutions, which delays the response and can lead to user dissatisfaction and lost productivity.

Artificial intelligence (AI) conversational systems, such as the Citrix Assistant commercially available from Citrix Systems, are software agents that interact with a user using a natural language such as English. In this way, the software agent can improve the user experience by providing a mode of interaction that is intuitive and easy to understand, not unlike a written or spoken conversation between two people. For example, the software agent can present information to the user in a natural language, receive instructions from the user in the natural language, and perform tasks on behalf of the user based on the information and/or the instructions without requiring the user to be versed in technical aspects of the system for performing routine tasks, such as troubleshooting and problem resolution.

To this end, techniques are disclosed for a conversational software agent for system troubleshooting and problem resolution. The software agent is configured to interact with users, support personnel, and other entities in a natural language. The software agent can, leveraging analytics engines and knowledge base components of the system, alert users and/or support personnel to anomalies and other adverse events, and assist those users and personnel to resolve any issues or concerns using a natural language interface, which promotes active, conversational interaction between the user/support personnel and the software agent. The software agent can be integrated with or otherwise interface with multiple applications and channels to provide application- and channel-specific support. In some examples, the software agent utilizes one or more knowledge bases to locate and provide information relevant to problem identification and resolution to the user or support personnel.

Example Computing Environment

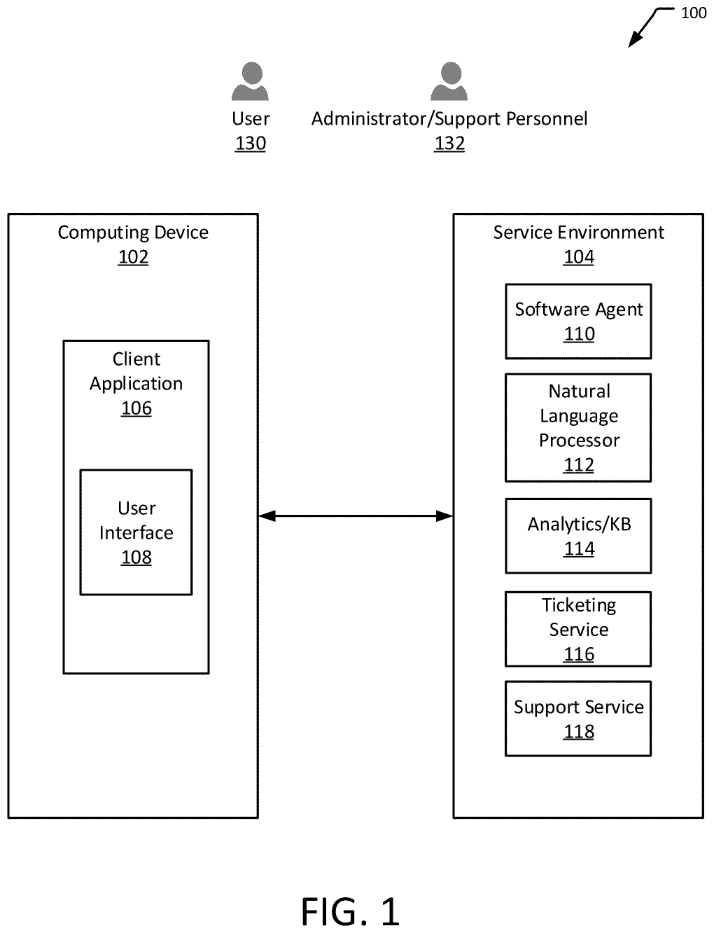

FIG. 1 is a block diagram of a computing environment 100, in accordance with an example of the present disclosure. The environment 100 includes a computing device 102 and a service environment 104. The computing device 102 is configured to execute one or more client applications 106 and to provide at least one graphical user interface 108. The service environment 104 is configured to provide a software agent 110, a natural language processor 112, an analytics engine/knowledge base 114, a ticketing service 116, and a support service 118. The computing device 102 and the service environment 104 can each be in communication with other components of the environment 100 using, for example, a local area network, a wide area network, or any type of wired or wireless network. One or more users 130 and one or more administrators or other support personnel 132 can interact with the environment 100, as will be described in further detail below.

In some examples, the software agent 110 is configured as an omni-channel bot that interacts with the user 130 in real-time via the client application 106 for troubleshooting and problem resolution. The software agent 110 monitors the user interface 108 of each client application 106 that has been registered with the agent 110 and interacts with the user 130 via the user interface 108 in a natural language (e.g., English). For example, for a Microsoft Teams channel, the software agent 110 can interact with the user 130 via the chat function of Teams using a natural language interface. The software agent 110 can, for example, inform the user 130 of how the environment is performing, alert the user 130 of any anomalies detected by the software agent 130 and/or by the analytics engine 114, and proactively notify the user 130 and/or other support personnel 132 of insights and suggested remedies for any issues or problems detected within the environment 100.

In some examples, the software agent 110 directly interacts with the user 130 and/or the administrator 132, which removes or reduces the number of manual time-consuming steps needed to address concerns that arise within the environment 100, such as black holes, overloaded processes, zombie processes, or other conditions that cause a poor user experience due to a problem at the user's end point (e.g., a local or virtual machine that is servicing the user). The software agent 110 is agnostic to the client application 106 and can be integrated with any application or website that includes the user interface 108.

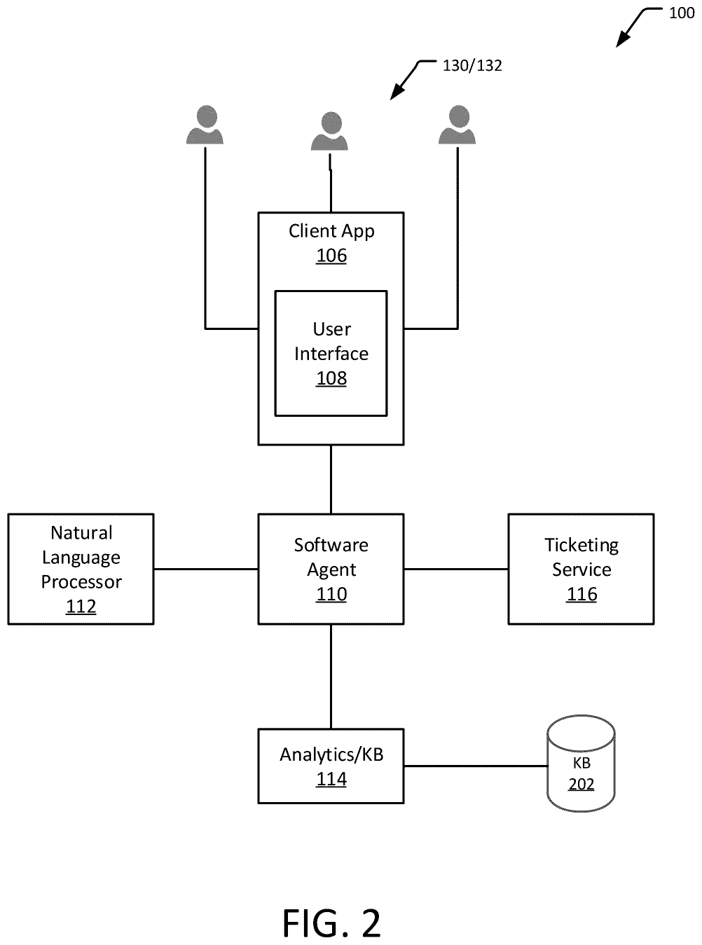

FIG. 2 is a block diagram of a portion of the computing environment 100 of FIG. 1, in accordance with an example of the present disclosure. The client application 106 is configured to provide the one or more graphical user interfaces 108, which permits a user 130 or administrator 132 to interact with the client application 106 and to view content (e.g., text, graphics, images, video, messages, interactive user elements such as buttons and checkboxes, text input fields, etc.) generated by the client application 106 or by any component of the service environment 104, including the software agent 110, the natural language processor 112, and/or the ticketing service 116 via the client application 106, for troubleshooting and problem resolution. In some examples, the client application 106 can execute locally within the computing device 102 or remotely (virtually) from the service environment 104.

In some examples, the environment 100 of FIGS. 1 and 2 includes a hardware and software framework for delivering and managing client applications (also referred to as channels), data, and desktops in a consistent and secure manner across multiple devices and locations. The environment 100 enhances the user experience by streamlining and automating certain tasks, such as collecting performance metrics relating to the client application 106 and other components of the environment 100 (including, for example, processors, communication interfaces (wired and wireless), and storage devices); monitoring the client application 106 and other components of the environment 100 for anomalous conditions and other potential performance concerns; and assisting the users/administrators 130, 132 in diagnosing and/or recovering from any concerns. In some examples, the environment 100 allows users 130 and administrators 132 to access functionality provided by multiple applications through a common user interface (e.g., the user interface 108), including software-as-a-service (SaaS) applications, web applications, desktop applications, enterprise applications, and proprietary applications.

In some examples, a user 130 or administrator 132 registers the software agent 110 with the client application 106. Once registered, the software agent 110 monitors the user interface 108 of the client application 106 and interacts with the user/administrator 130, 132 via the user interface 108. The software agent 110 interacts with the analytics engine/knowledge base 114 to obtain performance metrics relating to the application 106 and other information, such as expert documentation, that can be presented to the user 130 via the user interface 108. If multiple client applications 106 are registered with the software agent 110, then the software agent 110 monitors performance metrics for each registered client application 106 and interacts with the user 130 via the user interface 108 of each respective application 106. For instance, if one of the client applications 106 is an office productivity application and another one of the client applications 106 is a web conferencing application, the software agent 110 can monitor performance metrics for the office productivity application and for the web conferencing application, and interact with the user 130 via the respective applications 106 individually. In some examples, the administrator/support personnel 132 can interact with the software agent 110 independently via another user interface 108 of the client application 106, such as to provide remote support to the user 130 and/or to remotely control the client application 106 for troubleshooting and recovery purposes.

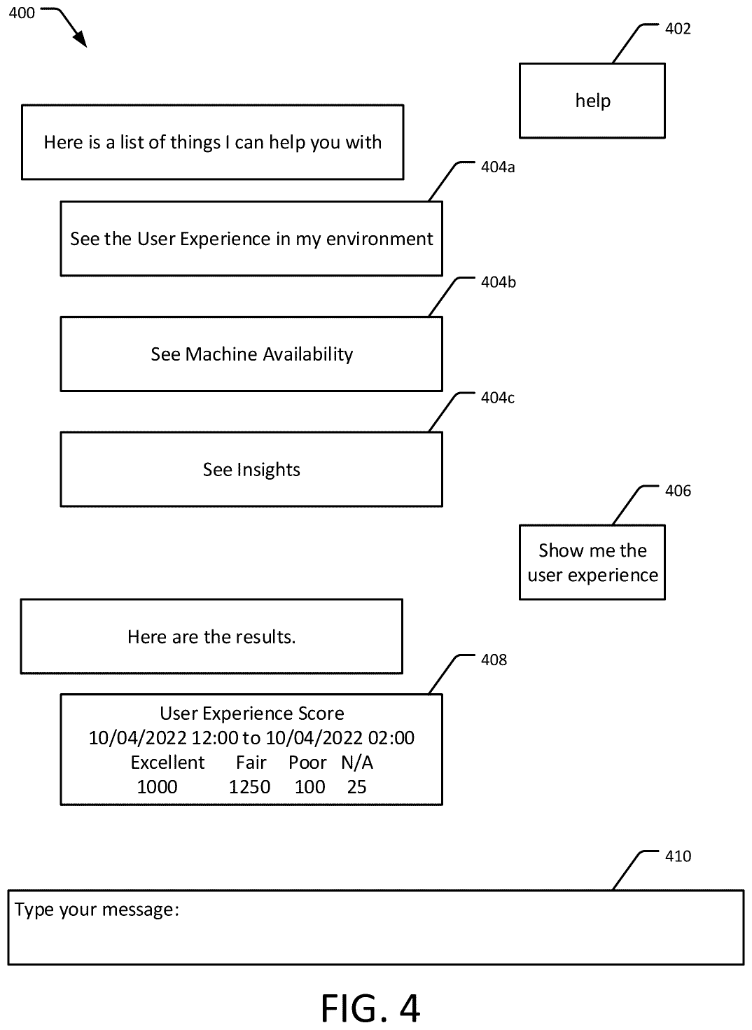

In some examples, the software agent 110 utilizes anomaly detection and insight features of the analytics engine/knowledge base 114 to collect performance metrics and/or to identify potential issues identified by the analytics engine 114 based on the collected performance metrics. The software agent 110 can also be customized or otherwise programmed to use features that are specific to a given client application 106. The software agent 110 communicates any identified issues or insights from the analytics engine/knowledge base 114 to the user/administrator 130, 132 via an interactive, conversational user interface 108, such as described with respect to FIGS. 4-7, by presenting relevant information to the user within the context of the application 106 and responding to user input in a natural language. The software agent 110 can further communicate recommended actions for the user/administrator 130, 132 to perform based on the performance metrics of the client application 106, or automatically take an action, or cause the computing device 102 and/or the client application 106 to perform the action, in response to a user input via the user interface 108 (e.g., the user can select a recommended action to be performed).

In some examples, the software agent 110 can notify the user/administrator 130, 132 of certain workflows within the computing device 102 and/or the client application 106, such as black holes (e.g., network traffic is discarded without notice), overloaded processes, zombie processes (e.g., a defunct process that has completed execution or otherwise terminated but failed to release memory and resources allocated to it), or a poor user experience due to an end point issue (e.g., slow or no response due to slow or no network communications or processing delays).

In some examples, the software agent 110 assists the user 130 with creating service tickets to request assistance from support personnel with a concern regarding the client application 106. The user 130 can, via the user interface 108, request the ticketing service 116 to create a service ticket via the software agent 110 using a natural language interface. For example, if the user 130, via an input to the user interface 108, requests that the service ticket is opened (e.g., user types “please reset my password”), the software agent 110 queries the natural language processor 112 to interpret the user request as an intent to create a service ticket. The natural language processor 112 uses unique identifying information of the user 130, the client application 106, and/or the computing device 102, such as a user identifier and a tenant identifier, to identify the applications 106 that the user 130 has used recently (e.g., within the prior 24 hours). The user 130 can designate, to the software agent 110, the application 106 causing the concern, which provides a unique session identifier corresponding to the selected application 106 to the software agent 110. In turn, the software agent 110 calls the analytics engine/knowledge base 114 via an application programming interface (API) using the session identifier to determine whether the session was launched on a machine which has been detected by an analytics engine 114 as having an issue.

The analytics engine 114 monitors the client application 106 and collects performance metrics relating to the client application 106 during execution within the environment 100. If the analytics engine 114 indicates to the software agent 110 that a known issue is present, the software agent 110 sends a response message or action message to the user 130 and/or the administrator 132 via the user interface 108 of the application 106 corresponding to the issue. For example, the software agent 110 can send the user 130 a message indicating a status of the session or recommending an action for the user 130 to take towards resolving the concern (such as restarting the application, clearing a cache, rebooting the machine, providing security credentials, etc.) If the analytics engine 114 indicates that no issue has been detected on the machine, the software agent 110 pre-populates a service ticket with relevant information (such as machine identifiers, session identifiers, IP address, diagnostic data, etc.) along with a user-provided description of the concern. The software agent 110 then requests that the ticketing service 116 create the service ticket for the user 130. The service ticket is forwarded to a support service (e.g., administrators 132 or other specialists) for further processing of the concern. In some examples, the support service 118 sends a response/service action message to the user 130 via the client application 106. The response/service action message can include, for example, a request for the user 130 to provide additional details, such as a description of the concern or any errors encountered by the user 130, or a response to a question posed by the administrator 132 or specialist; a recommended action for the user 130 to take, such as rebooting the machine, entering security credentials, resetting a browser, etc.; and/or other information or questions that the administrator/specialist 132 wishes to convey to the user 130 as part of the resolution process.

In some examples, the ticketing service 116 uses clustering techniques to group multiple service tickets together based on, for example, concerns regarding a certain machine, application, and/or description of a concern, so that the support personnel can process similar tickets together. This is useful, for example, in situations where each of the service tickets can be addressed by a common resolution, such as installing a software update, resetting a database, or reconfiguring a network connection. In some examples, administrators 132 can configure thresholds for alert triggering, e.g., if more than three issues have been reported on a virtual delivery agent (e.g., a service that delivers applications and/or desktops in a virtual desktop environment), the software agent 110 alerts the administrator via the channel. The software agent 110 retrieves an analytics result (e.g., performance metrics or relevant documents) from the analytics engine/knowledge base 114 related to the description on the service ticket and presents the analytics result to the user 130 via the user interface 108 of the respective client application 106.

In some examples, the software agent 110 can access, via the analytics engine/knowledge base 114, a knowledge database 202 of frequently asked questions (FAQs) populated by users and system administrators. By monitoring the application 106, the software agent 110 interprets user questions entered via the user interface 108 using natural language processing and searches the knowledge base 202 based on the natural language interpretation of the user questions to retrieve relevant documents from the knowledge base 202 and present the documents to the user 130 via the user interface 108.

In some examples, the client application 106 is registered with the software agent 110 at the discretion of the user 130 or other customer responsible for operating the user's computing environment. The software agent 110 can be registered on an application-by-application basis; for example, for each application 106 or workspace that is supported by the software agent 110. The analytics engine 114 can call the software agent 110 via an API to monitor the registered applications 102 and respond to any anomalies or other insights generated by the analytics engine 114. The software agent 110 can, in turn, identify individual users 130 and administrators 132 based on information provided by the analytics engine 114 and send messages or other information to those users 130, 132 via the application(s) 106 alerting the users 130, 132 to certain conditions relating to the anomalies or insights. For example, the messages can include instructions for recovering from a service interruption, user interface elements (e.g., buttons or switches) that the user 130, 132 can select to cause certain recovery actions to occur, or other information to assist or otherwise inform the user 130, 132 regarding the concern. The messages and associated recovery actions can be determined, for example, using machine learning techniques to identify suitable actions based on the detected anomalies.

In some examples, the administrator 132 can obtain performance and diagnostic data from the computing environment via the software agent 110. For example, the software agent 110 can forward processor, application, and/or network performance monitoring data from the computing device 102 to the support personnel.

In some examples, the user 130 can extend the capabilities and functionality of the software agent 110 with additional code or training. For example, the additional training can include adding, to the natural language processor, new natural language sentences corresponding to certain use cases, recovery actions, etc.

Example Data Flow

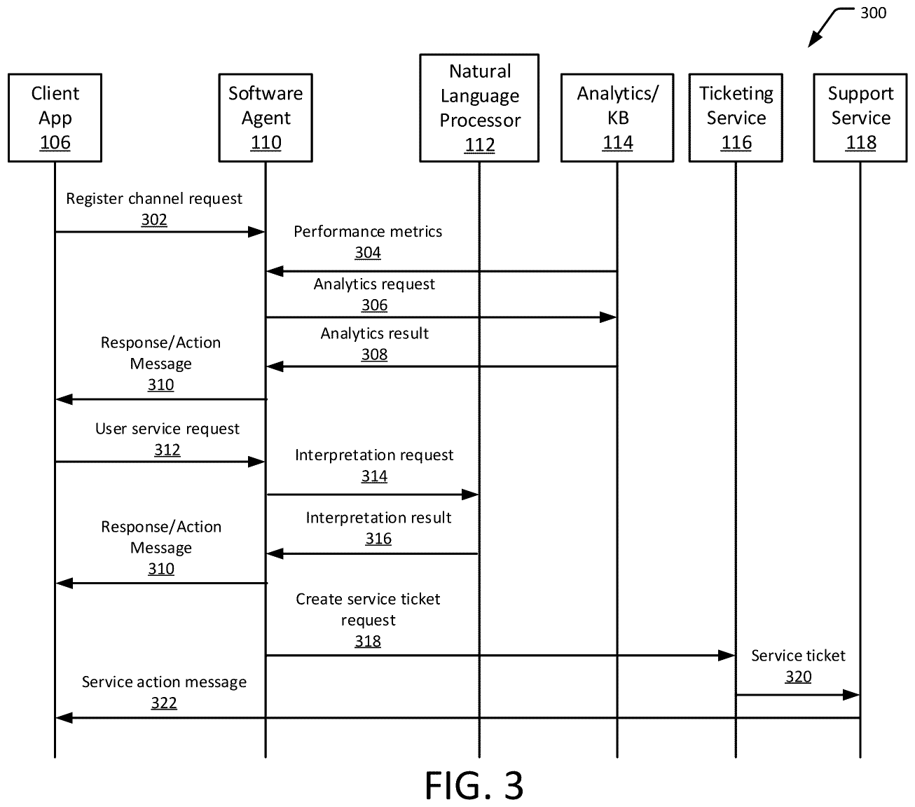

FIG. 3 is a data flow diagram 300 for the computing environment 100 of FIG. 1, in accordance with an example of the present disclosure. Initially, the user registers the client application 106 with the software agent 110 for troubleshooting and problem resolution. The client application 106 sends a register channel request 302 to the software agent 110. The register channel request 302 can include a tenant identifier or other information uniquely identifying the client application 106 and the execution environment (e.g., machine identifier, network address, etc.) After the client application 106 is registered with the software agent 110, the software agent 110 receives client application performance metrics 304 from the analytics engine 114. For example, the analytics platform 114 can be configured to monitor the client application 106 and the corresponding workflows of the user 130 to identify any anomalous conditions or other performance issues, such as poor user experience due to delays, unresponsive processes, or communications errors. The analytics engine 114 can send the performance metrics 304 to the software agent 110 via an API call to the software agent 110.

In turn, the software agent 110 sends an analytics request 306 to the analytics engine 114. The analytics request 306 can include a request for further information from the analytics engine 114, such as a user identifier associated with the performance metrics 304. The software agent 110 then receives an analytics result 308 from the analytics engine 114. The analytics result 308 can include information responsive to the analytics request 306, such as the user identifier associated with the performance metrics 304. Using the information in the analytics result 308 and the performance metrics 304, the software agent 110 can select a message from a database. The message can include information relevant to the performance metrics 304. For example, if the performance metrics 304 indicate that a zombie process is present, the software agent 110 can select a message that informs the user of the issue along with a recommended action or actions to resolve the issue. The software agent 110 sends a response/action message 310 to the client application 106, which displays the message 310 to the user via a natural language interface, such as described with respect to FIGS. 4-7.

In some examples, the software agent 110 receives a user service request 312 from the client application 106. The user service request 312 can include text in a natural language where the user requests assistance with the client application 106, such as “help” or “I'm having a problem.” The software agent 110 sends an interpretation request 314 to the natural language processor, which interprets the user service request 312 and returns an interpretation result 316 to the software agent 110. The interpretation result 316 represents an intent of the user as expressed in the user service request 312, such as an intent of the user to obtain further information regarding the concern or an intent to open a service ticket. In some examples, the software agent 110 includes, in the response/action message 310, information responsive to the user service request 312, such as further questions for the user to answer (such as to provide additional comments on the concern) or expert documentation to assist the user with the concern (such as a frequently asked questions document). In some other examples, the software agent 110 interprets the user service request 312 as an intent to open a service ticket and sends a create service ticket request 318 to the ticketing service. The create service ticket request 318 can include, for example, information about the computing environment 100, such as the tenant identifier, the user identifier, the performance metrics 304, and any other information that can be used to identify or otherwise describe the concern. This information is automatically populated into the service ticket by the ticketing service 116, which sends a service ticket 320 to the support service for further processing. The support service 118 responds to the service ticket 320 by sending a service action message 322 to the client application 106 either directly or via the software agent 110.

Example User Interfaces

FIG. 4 is a graphical user interface 400 that can be implemented in the computing environment 100 of FIG. 1, in accordance with an example of the present disclosure. The user interface 400 can include a natural language chat environment, where the user types natural language statements into the user interface 400 and the software agent 110 provides natural language responses to the user for troubleshooting and problem resolution. For instance, at 402 the user types “help” into the user interface 400. In this example, the “help” statement is the user service request 312 of FIG. 3, which is received and processed by the software agent 110. The software agent 404, responds by sending the response/action message 310 of FIG. 3 to the user interface 400, which displays the content of the response/action message 310 as follows: “Here is a list of things I can help you with” followed by one or more message boxes 404a, 404b, 404c from which the user can see his or her choices. The user can either select one of the message boxes 404a, 404b, 404c via the user interface 400, or type in a natural language response, such as shown at 406 to indicate the user's choice. In turn, the software agent 110 can provide further information according to the user's choice, as indicated at 408. The user interface 400 can include a text entry field 410 for the user to type questions, requests, and answers into.

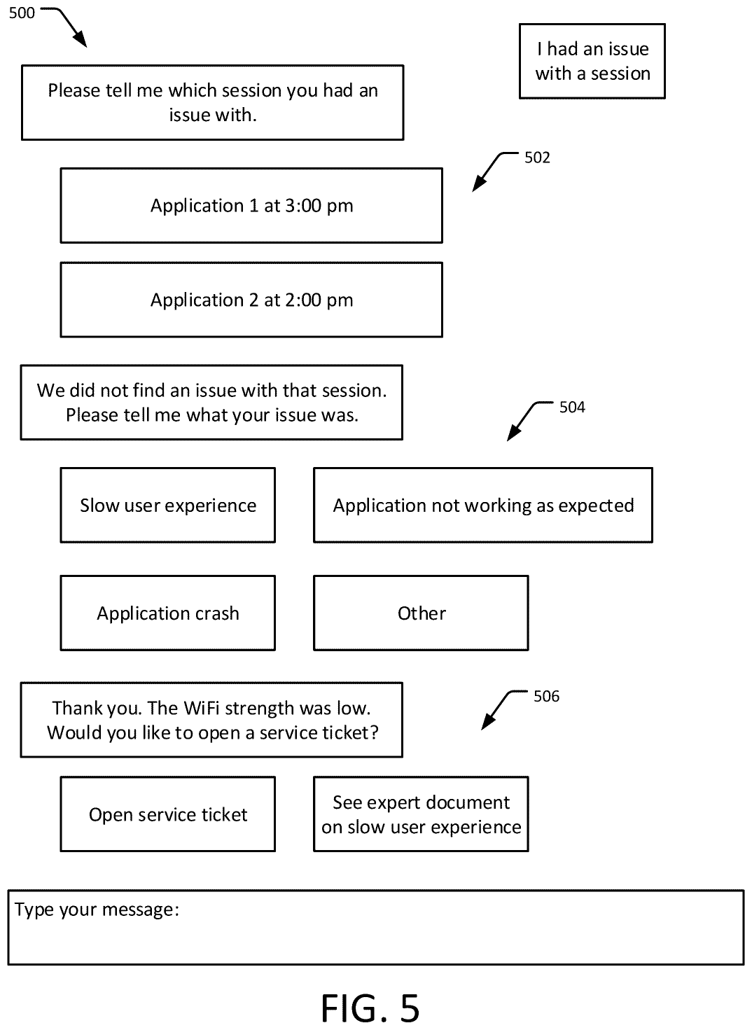

FIG. 5 is a graphical user interface 500 that can be implemented in the computing environment 100 of FIG. 1, in accordance with another example of the present disclosure. In this example, the user types natural language statements into the user interface 500 and the software agent 110 provides natural language responses to the user, such as described with respect to FIG. 4. Here, the software agent 110 asks the user to provide further information regarding a particular session, and offers the user a choice of several sessions, as indicated at 502. The user can then select one of the options and the software agent 110 can proceed based on the user selection, such as by asking the user to provide yet further information about the concern, as indicated at 504. The user can again select the appropriate choice and the software agent 110 can respond with options to open a service ticket or to provide expert documentation related to the user's concern, as indicated at 506.

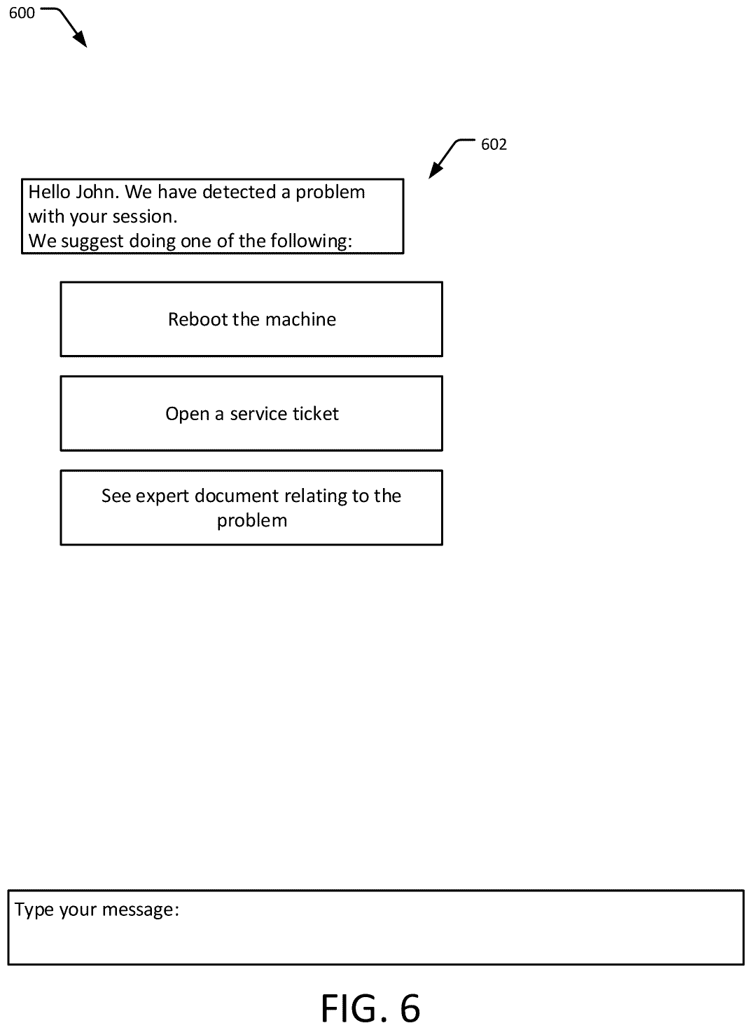

FIG. 6 is a graphical user interface 600 that can be implemented in the computing environment 100 of FIG. 1, in accordance with yet another example of the present disclosure. In this example, the software agent 110 detects a problem in the user's session and proactively sends a message to the user via the user interface 600, along with one or more action items for resolving the problem, as indicated at 602. The user can then select one of the actions, and the software agent 110 will cause the computing environment 100 to perform the action automatically (e.g., reboot the machine, open a service ticket, or provide expert documentation).

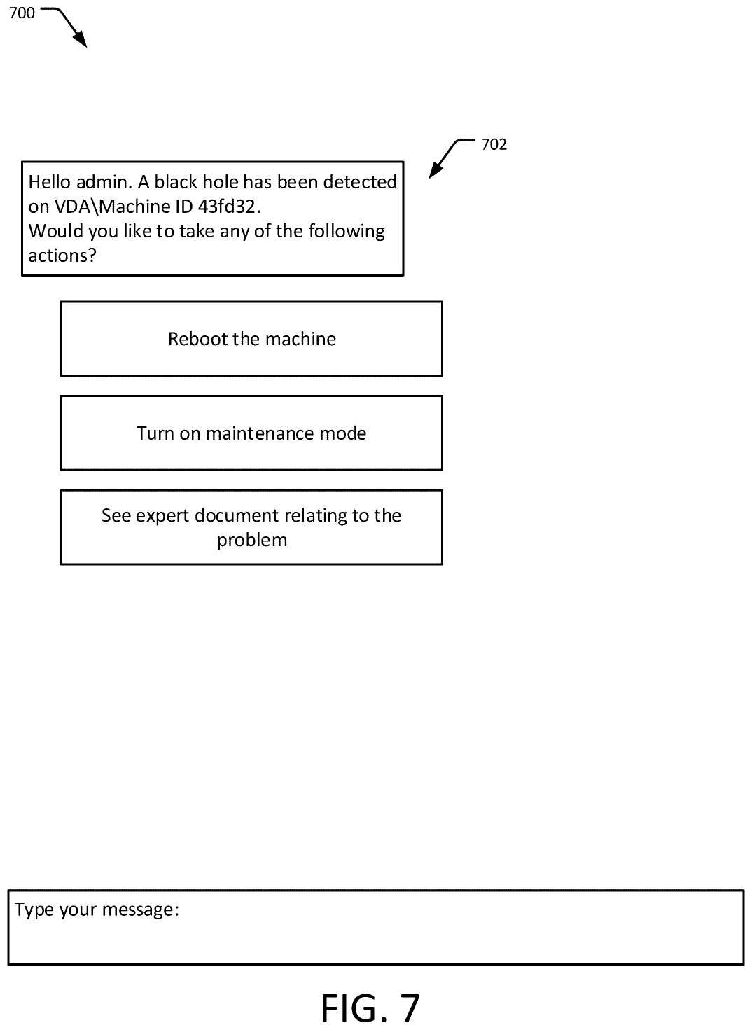

FIG. 7 is a graphical user interface 700 that can be implemented in the computing environment 100 of FIG. 1, in accordance with yet another example of the present disclosure. In this example, similar to the example of FIG. 6, the software agent 110 detects a problem in the user's session. However, in this example, the software agent 110 proactively sends a message to the administrator or other support personnel via the user interface 700, along with one or more action items for resolving the problem, as indicated at 702. The administrator/support personnel can then select one of the actions, and the software agent 110 will cause the computing environment 100 to perform the action automatically (e.g., reboot the machine, open a service ticket, or provide expert documentation).

Example Method

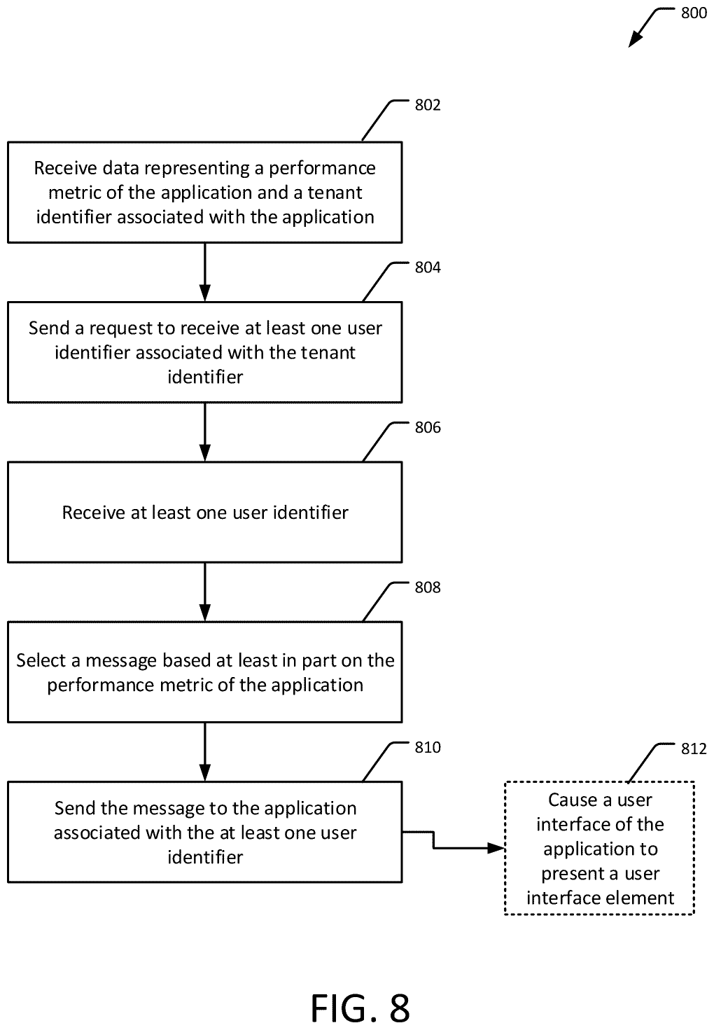

FIG. 8 is a flow diagram of a method 800 of troubleshooting an application within the computing environment 100 of FIG. 1, in accordance with an example of the present disclosure. The method 800 includes receiving 802, from an analytics engine, data representing a performance metric of the application and a tenant identifier associated with the application. As discussed above, the tenant identifier can be used to uniquely identify the computing environment 100 including the client application 106, and the performance metric can include information regarding the performance of the client application 106 within the computing environment 100. The method 800 further includes sending 804, to the analytics service, a request to receive at least one user identifier associated with the tenant identifier and a machine identifier (e.g., a media access control (MAC) address) of the machine and/or an Internet Protocol (IP) address of the machine. The method 800 further includes receiving 806, from the analytics service, at least one user identifier. Here, for example, the analytics service provides one or more user identifiers, such as a username or other data to uniquely identify users in the computing environment 100, and more specifically, users of the client application 106. This allows the software agent to interact with specific users in the environment 100 who may be encountering issues with the client application 106.

The method 800 further includes selecting 808, from a database, a message based at least in part on the performance metric of the application. For example, if the performance metric indicates that a process associated with the client application 106 is unresponsive, the message selected can provide the user with information about the unresponsive process and/or recommended actions to recover from the unresponsive process, such as rebooting the machine, opening a service ticket, or fetching expert documentation relating to the unresponsive process. The method 800 further includes sending 810 the message to the application associated with the at least one user identifier. The message can then be presented or otherwise displayed to the user via a graphical user interface, such as described with respect to FIGS. 4-7. The user can further interact via the user interface to take actions or provide additional information about the concern. For example, the method 800 can include causing 812 a user interface of the application to present a user interface element configured to cause, responsive to a user selection of the user interface element, an action to be performed on a client computing device executing the application, such as restarting the client application, rebooting the machine, terminating the unresponsive process, etc.

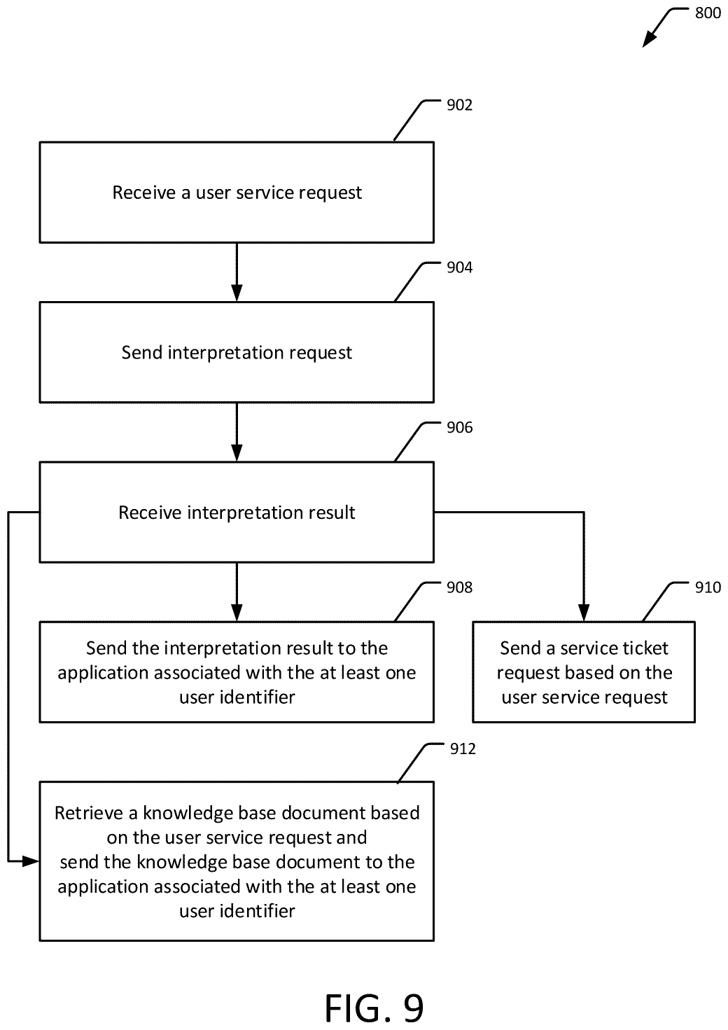

FIG. 9 is a flow diagram of a method 900 of troubleshooting an application within the computing environment 100 of FIG. 1, in accordance with another example of the present disclosure. The method 900 can include one or more acts described with respect to the method 800 of FIG. 9. The method 900 includes receiving 902, from the application associated with the at least one user identifier, a user service request. The user service request can include any text entered by the user into a user interface of the application, such as a request for assistance with the application. The method 900 further includes sending 904, to a natural language processor, an interpretation request based on the user service request and receiving 906, from the natural language processor, an interpretation result. The interpretation result can represent, for example, an intent of the user to receive recommendations for resolving the user service request and/or an intent of the user to open a service ticket. The method 900 further includes sending 908 the interpretation result (e.g., a recommended action for resolving the concern) to the application associated with the at least one user identifier. The method 900 further includes sending 910, to a ticketing service, a service ticket request based on the user service request, such as when the interpretation result indicates a user intent to open a service ticket. The method 900 further includes retrieving 912, from a knowledge base, a knowledge base document based on the user service request and sending the knowledge base document to the application associated with the at least one user identifier, such as when the interpretation result indicates a user intent to receive expert documentation relating to the user service request.

In some examples, the method 800 and/or the method 900 can include receiving, from the analytics engine, second data representing performance metrics of the application hosted on a plurality of virtual computing sessions and sending, responsive to receiving the second data, the message to an administrator of the virtual computing sessions. This can occur, for example, when the analytics service detects that multiple users are experiencing the same or similar problems with the client application, and that the administrator/support personnel may be in a better position to address the concerns than the individual users.

Example Computing Device

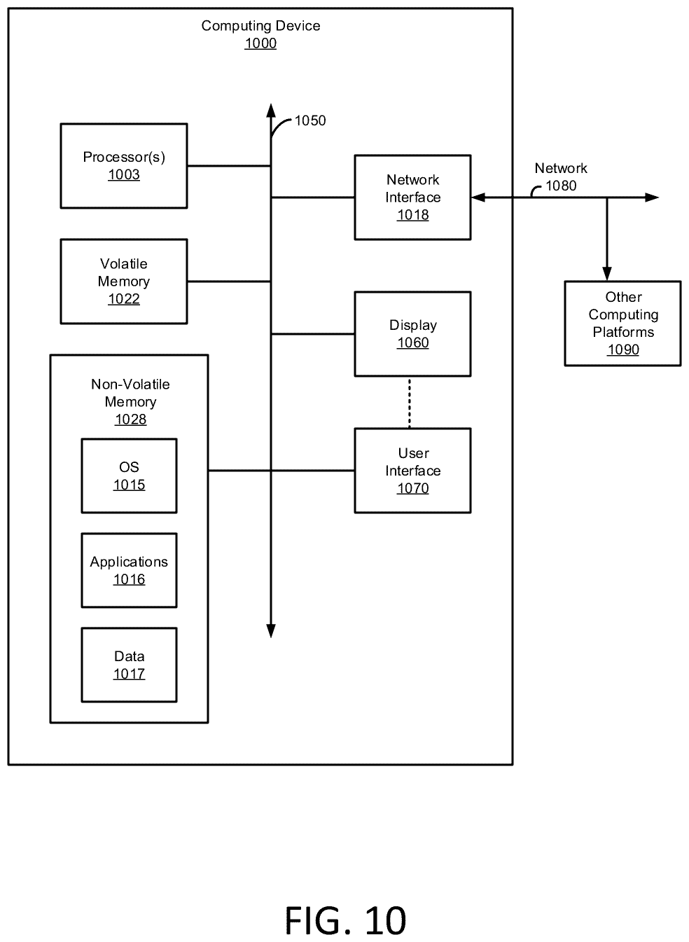

FIG. 10 is a block diagram of a computing device 1000 configured to implement various systems and processes in accordance with examples disclosed herein. It will be understood that multiple computing devices 1000 can be implemented according to the examples provided herein, where each of the computing devices 1000 is configured to perform certain functions in conjunction with other computing devices 1000. In some examples, the computing device 1000 can include a workstation, a laptop computer, a tablet, a mobile device, or any suitable computing or communication device. One or more components of the computing device 1000, including the computing device 102 and/or the service environment 104 of FIG. 1, can include or otherwise be executed using one or more processors 1003, volatile memory (e.g., random access memory (RAM)) 1022, non-volatile machine-readable mediums (e.g., a non-volatile memory 1028), one or more network or communication interfaces 1018, a display 1060, a user interface (UI) 1070, and a communications bus 1050. The non-volatile (non-transitory) machine-readable mediums 1028 can include: one or more hard disk drives (HDDs) or other magnetic or optical machine-readable storage media; one or more machine-readable solid state drives (SSDs), such as a flash drive or other solid-state storage media; one or more hybrid machine-readable magnetic and solid-state drives; and/or one or more virtual machine-readable storage volumes, such as a cloud storage, or a combination of such physical storage volumes and virtual storage volumes or arrays thereof. The user interface 1070 can include one or more input/output (I/O) devices (e.g., a mouse, a keyboard, a touch screen/monitor/panel, a microphone, one or more speakers, etc.). The display 1060 can provide a graphical user interface (GUI). The non-volatile memory 1028 stores an operating system (OS), one or more applications, and data such that, for example, computer instructions of the operating system and the applications, are executed by processor(s) out of the volatile memory. In some examples, the volatile memory 1022 can include one or more types of RAM and/or a cache memory that can offer a faster response time than the non-volatile memory 1028. Data can be entered through the user interface 1070. Various elements of the computing device 1000 can communicate via the communications bus 1050 or the network interface 1018.

The computing device 1000 can also be referred to as a client device, a computing device, a client computing device, an endpoint device, a computer, a computer system, or a server. The computing device 1000 is shown as an example of the computing device 102 and/or the server 104 and can be implemented within any computing or processing environment with any type of physical or virtual machine or set of physical and virtual machines that can have suitable hardware and/or software capable of operating as described herein. In some examples, some components of the computing device can be implemented virtually (e.g., using a combination of hardware and software), such as to provide user interface 108 to the client application client 106 of the computing device 102, where the client application 106 emulates certain processing functions of the computing device 102 (e.g., including at least portions of the methods 800 and 900 of FIGS. 8 and 9) using hardware components of the computing device 102 (e.g., processors, network communications hardware, I/O devices, etc.).

The non-volatile memory 1028 stores the OS 1015, one or more applications or programs 1016 (e.g., the client application 106), and data 1017 (e.g., the performance metrics 302, the response/action message 310, the user service request 312, the interpretation request 314, interpretation result 316, the create service ticket request 318, and/or the service action message 322). The OS 1015 and the applications 1016 include sequences of instructions that are encoded for execution by processor(s) 1003. Execution of these instructions results in manipulated data. Prior to their execution, the instructions can be copied to the volatile memory 1022. In some examples, the volatile memory 1022 can include one or more types of RAM and/or a cache memory that can offer a faster response time than a main memory. Data can be entered through the user interface 1070 (e.g., the user interface 108) or received from the other I/O device(s), such as the network interface 1018. The various elements of the computing device 1000 described above can communicate with one another via the communications bus 1050 and/or via the network interface 1018 to other computing platforms 1090.

The processor(s) 1003 can be implemented by one or more programmable processors to execute one or more executable instructions, such as a computer program, to perform the functions of the system. As used herein, the term “processor” describes circuitry or hardware that performs a function, an operation, or a sequence of operations. The function, operation, or sequence of operations can be hard coded into the circuitry or a data storage device, or soft coded by way of instructions held in the storage device and executed by the circuitry. A processor can perform the function, operation, or sequence of operations using digital values and/or using analog signals. In some examples, the processor can include one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory. The processor(s) 1003 can be analog, digital, or a combination of these. In some examples, the processor(s) 1003 can be one or more local physical processors or one or more remotely located physical processors. A processor including multiple processor cores and/or multiple processors can provide functionality for parallel, simultaneous execution of instructions or for parallel, simultaneous execution of one instruction on more than one piece of data.

The network interfaces 1018 can include one or more interfaces to enable the computing device 1000 to access a computer network 1080 such as a Local Area Network (LAN), a Wide Area Network (WAN), a Personal Area Network (PAN), or the Internet through a variety of wired and/or wireless connections, including cellular connections and Bluetooth connections. In some examples, the network 1080 may allow for communication with other computing devices 1090, such as the computing device 102 and/or the service environment 104, to enable distributed, shared, or cooperative computing (e.g., such as cooperatively functioning to display to, and remove or blank content from, the user interface 108). The network 1080 can include, for example, one or more private and/or public networks over which computing devices can exchange data.

In described examples, the computing device 1000 can execute an application on behalf of a user (e.g., the user 130) of the computing device 102. For example, the computing device 1000 can execute one or more virtual machines managed by a hypervisor. Each virtual machine can provide an execution session within which applications execute on behalf of a user or a client device, such as a hosted desktop session. The computing device 1000 can also execute a terminal services session to provide a hosted desktop environment. The computing device 1000 can provide access to a remote computing environment including one or more applications, one or more desktop applications, and one or more desktop sessions in which one or more applications can execute.

The foregoing description and drawings of various embodiments are presented by way of example only. These examples are not intended to be exhaustive or to limit the present disclosure to the precise forms disclosed. Alterations, modifications, and variations will be apparent in light of this disclosure and are intended to be within the scope of the present disclosure as set forth in the claims. For example, the processes disclosed herein each represent a sequence of acts in a particular example. Some acts are optional and, as such, can be omitted in accord with one or more examples. Additionally, the order of acts can be altered, or other acts can be added, without departing from the scope of the apparatus and methods discussed herein.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method of troubleshooting an application, the method comprising:
receiving, from an analytics engine, data representing a performance metric of the application and a tenant identifier associated with the application;
sending, to the analytics service, a request to receive at least one user identifier associated with the tenant identifier;
receiving, from the analytics service, at least one user identifier;
selecting, from a database, a message based at least in part on the performance metric of the application; and
sending the message to the application associated with the at least one user identifier.

2. The method of claim 1, further comprising causing a user interface of the application to present a user interface element configured to cause, responsive to a user selection of the user interface element, an action to be performed on a client computing device executing the application.

3. The method of claim 1, further comprising receiving, from the application associated with the at least one user identifier, a user service request.

4. The method of claim 3, further comprising:
sending, to a natural language processor, an interpretation request based on the user service request;
receiving, from the natural language processor, an interpretation result; and
sending the interpretation result to the application associated with the at least one user identifier.

5. The method of claim 3, further comprising sending, to a ticketing service, a service ticket request based on the user service request.

6. The method of claim 3, further comprising:
retrieving, from a knowledge base, a knowledge base document based on the user service request; and
sending the knowledge base document to the application associated with the at least one user identifier.

7. The method of claim 1, wherein the data is first data, and wherein the method further comprises:
receiving, from the analytics engine, second data representing performance metrics of the application hosted on a plurality of virtual computing sessions; and
sending, responsive to receiving the second data, the message to an administrator of the virtual computing sessions.

8. A computer program product including one or more non-transitory machine-readable mediums having instructions encoded thereon that when executed by at least one processor cause a process for troubleshooting an application to be carried out, the process comprising:
receiving, from an analytics engine, data representing a performance metric of the application and a tenant identifier associated with the application;
sending, to the analytics service, a request to receive at least one user identifier associated with the tenant identifier;
receiving, from the analytics service, at least one user identifier;
selecting, from a database, a message based at least in part on the performance metric of the application; and
sending the message to the application associated with the at least one user identifier.

9. The computer program product of claim 8, wherein the process further comprises causing a user interface of the application to present a user interface element configured to cause, responsive to a user selection of the user interface element, an action to be performed on a client computing device executing the application.

10. The computer program product of claim 8, wherein the process further comprises receiving, from the application associated with the at least one user identifier, a user service request.

11. The computer program product of claim 10, wherein the process further comprises:
sending, to a natural language processor, an interpretation request based on the user service request;
receiving, from the natural language processor, an interpretation result; and
sending the interpretation result to the application associated with the at least one user identifier.

12. The computer program product of claim 10, wherein the process further comprises sending, to a ticketing service, a service ticket request based on the user service request.

13. The computer program product of claim 10, wherein the process further comprises:
retrieving, from a knowledge base, a knowledge base document based on the user service request; and
sending the knowledge base document to the application associated with the at least one user identifier.

14. The computer program product of claim 8, wherein the data is first data, and wherein the process further comprises:
receiving, from the analytics engine, second data representing performance metrics of the application hosted on a plurality of virtual computing sessions; and
sending, responsive to receiving the second data, the message to an administrator of the virtual computing sessions.

15. A system comprising:
a storage; and
at least one processor operatively coupled to the storage, the at least one processor configured to execute instructions stored in the storage that when executed cause the at least one processor to carry out a process comprising
causing a graphical user interface (GUI) of the device to display content in an application window;
receiving, from an analytics engine, data representing a performance metric of the application and a tenant identifier associated with the application;
sending, to the analytics service, a request to receive at least one user identifier associated with the tenant identifier;
receiving, from the analytics service, at least one user identifier;
selecting, from a database, a message based at least in part on the performance metric of the application; and
sending the message to the application associated with the at least one user identifier.

16. The system of claim 15, wherein the process further comprises causing a user interface of the application to present a user interface element configured to cause, responsive to a user selection of the user interface element, an action to be performed on a client computing device executing the application.

17. The system of claim 15, wherein the process further comprises receiving, from the application associated with the at least one user identifier, a user service request.

18. The system of claim 17, wherein the process further comprises:
sending, to a natural language processor, an interpretation request based on the user service request;
receiving, from the natural language processor, an interpretation result; and
sending the interpretation result to the application associated with the at least one user identifier.

19. The system of claim 17, wherein the process further comprises sending, to a ticketing service, a service ticket request based on the user service request.

20. The system of claim 17, wherein the process further comprises:
retrieving, from a knowledge base, a knowledge base document based on the user service request; and
sending the knowledge base document to the application associated with the at least one user identifier.
